(19) United States
(12) Patent Application Publication
(10) Pub. No.: US 2008/0210111 A1
(43) Pub. Date: Sep. 4, 2008

(54) Web-Fed Rotary Press and Method for Minimizing Fluting in a Web-Fed Rotary Press

(75) Inventors: Clemens De Vroome, Beugen (NL); Franciscus Ernst, Vortum-Mullen (NL); Roeland Van Veen, Den Bosch (NL)

Correspondence Address: Davidson, Davidson & Kappel, LLC, 485 7th Avenue, 14th Floor, New York, NY, 10018, US

(73) Assignee: Goss Contiweb B.V., Boxmeer (NL)

(21) Appl. No.: 10/581,477

(22) PCT Filed: Nov. 25, 2004
(86) PCT No.: PCT/EP04/13489

§ 371 Date: Apr. 21, 2008

(30) Foreign Application Priority Data
Dec. 3, 2003 (DE) 10356995.2

(51) Int. Cl. B41F 5/04; B41L 35/14

(52) U.S. Cl. 101/219; 101/488

(57) ABSTRACT

A web-fed rotary press (10) for printing on a web substrate (12) using heat-set inks in an offset printing process, having at least one print unit (14) and one dryer (16), and at least one additional device (18) for inputting heat into the web substrate (12) which is positioned upstream from the print unit (14), in particular. Fluting in the web-fed rotary press (10) may be minimized by supplying heat to the web substrate (12) at least at one location along the path (36) through the web-fed rotary press (10), in particular before the printing operation.

The present invention is directed to a web-fed rotary press for printing on a web substrate using heat-set inks in an offset printing process, having at least one print unit and one dryer. The present invention is also directed to a method for minimizing fluting in a web-fed rotary press for printing on a web substrate using heat-set inks in an offset printing process, a web substrate, which is guided through the web-fed rotary press along a path, being printed on by at least one print unit and, once imprinted, being dried.

Flutes, also referred to as fluting formations, are corrugated folds, creases or deformations occurring substantially in the longitudinal direction of a printing substrate that is processed in a web-fed rotary press. Flutes of this kind have wavelengths of approximately between 5 and 50 mm and typically an amplitude of between several tenths of a millimeter and several millimeters. After a web substrate is processed by one or more print units and a dryer in a printing press, it can happen that flutes are impressed on or set into the end product, also referred to as a signature. This is typically the case when so-called thermohardening or heat-set inks are used. Flutes of this kind in the end product, particularly when working with heat-set inks, are considered as negatively affecting or being detrimental to the goal of attaining a high-quality product. Although, to date, no extensive research has been conclusively conducted to determine the influencing parameters, evidence suggests that the following circumstances influence the formation of fluting: coated paper has a greater tendency to form flutes than does uncoated paper. A heavier ink coverage produces greater fluting than does a lighter ink coverage. A high web temperature tends to result in longer flutes being formed than does a low web temperature. The severity of the fluting is often described by the so-called fluting quality index: this dimensionless number is defined as the quotient of the amplitude of the flutes in micrometers divided by the wavelength in millimeters.

To minimize fluting, U.S. Pat. No. 6,058,844 describes spreading or stretching the web substrate in the transversal direction (in the width-wise direction, thus transversely to the conveyance direction), when the imprinted web has exited a dryer downstream from the print units and is guided over chill rolls. For this purpose, the chill rolls are each designed to have a convexly curved lateral surface.

The European Patent Application EP 1 201 429 A2 discusses a device for cooling a web substrate, in particular a paper web, in which the web is directed in a meander-shaped path over a number of chill rolls around which the web partially loops, negative and positive curvatures of the web alternating with each other. A controlled hardening or setting of the ink is thereby effected, making it possible to minimize fluting. This document EP 1 201 429 A2 is incorporated by reference herein.

The object of the present invention is to minimize or even to entirely prevent the occurrence of fluting on a web substrate in a web-fed rotary press.

This objective is achieved in accordance with the present invention by a web-fed rotary press having the features set forth in claim 1 and/or by a method having the features as set forth in claim 9. Advantageous refinements of the present invention are delineated in the dependent claims.

In accordance with the present invention, a web-fed rotary press for printing on a web substrate using at least one heat-set ink (thermohardening ink), preferably a plurality of heat-set inks, in an offset printing process, has at least one print unit, one dryer, and at least one additional device for inputting heat into the web substrate. In particular, along the path of the web substrate through the web-fed rotary press, the device for inputting heat may be positioned upstream from the at least one print unit, preferably directly upstream the print unit. This mean that the web substrate passes the device temporally and, respectively, spatially before it passes through the at least one print unit. The web-fed rotary press may also be described as a rotary offset press.

The present invention is based, inter alia, on the idea of removing moisture from the printing substrate in a temporally and locally controlled manner. In this way, shrinkage or deformation of the printing substrate in the dryer, which is considered to be a principal factor in the formation of fluting, is able to be minimized or even prevented. The moisture may be removed, in particular prior to printing on the printing substrate, by a contacting or a non-contacting device. The moisture added by the offset printing process in the print unit or print units substantially remains on the surface of the substrate web, given an adequate web velocity, in particular at typical production speeds. The time period necessary for an absorption is not reached, and the moisture is already vaporized in the dryer before it can penetrate more deeply into the web substrate.

Heat may be applied in various ways in specific embodiments: In a web-fed rotary press according to the present invention, the device for inputting heat may include at least one steam-heatable roller and/or at least one water-heatable roller and/or at least one microwave source and/or at least one infrared light source, heatable rollers being preferred in particular.

In one particularly advantageous refinement, the device for inputting heat may include at least one cooling unit, which is arranged in the last position along the path of the web substrate through the device for inputting heat. In one beneficial specific embodiment, the cooling unit may include a number of chill rolls. The chill roll unit may, in particular, have features as described in European Patent Application EP 1 201 429.

In addition or alternatively thereto, the device for inputting heat in a web-fed rotary press according to the present invention may have at least one device for producing a lateral tension in the web substrate. The lateral direction may also be described as the widthwise direction of the web substrate, thus the direction transversely to the conveyance direction. In one advantageous embodiment, the device for producing a lateral tension may have a number of motorless belts and/or a number of grippers.

Another alternative or supplementary advantageous embodiment provides that the device for inputting heat of the web-fed rotary press according to the present invention be fed by the exhaust air from the dryer. In other words, the energy still contained in the exhaust air may be used for expelling the moisture at another location along the path of the web substrate.

The web-fed rotary press according to the present invention may be a commercial web press or a newspaper printing press, thus, in particular, a web-fed rotary press that processes a plurality of web substrates. Multiple colors, preferably four colors may be used for printing on each web substrate. The printing substrate may be uncoated, smooth, or coated paper or a packaging material, such as sheeting of organic or metallic material, for example.

Also included in the context of the inventive idea is a method for minimizing fluting in a web-fed rotary press for printing on a web substrate using heat-set inks in an offset printing process. A web substrate is guided through the web-fed rotary press along a path. The web substrate is printed on using at least one print unit. Once imprinted, the web substrate is dried. Heat is supplied to the web substrate at least at one other location, in particular prior to the printing operation, along the path through the web-fed rotary press. In one advantageous embodiment of the method, the web substrate is tensioned laterally during the heat input operation at the at least one other location.

Further advantages, advantageous embodiments and refinements of the present invention are described with reference to the following figures, as well as their descriptions. Specifically, they show:

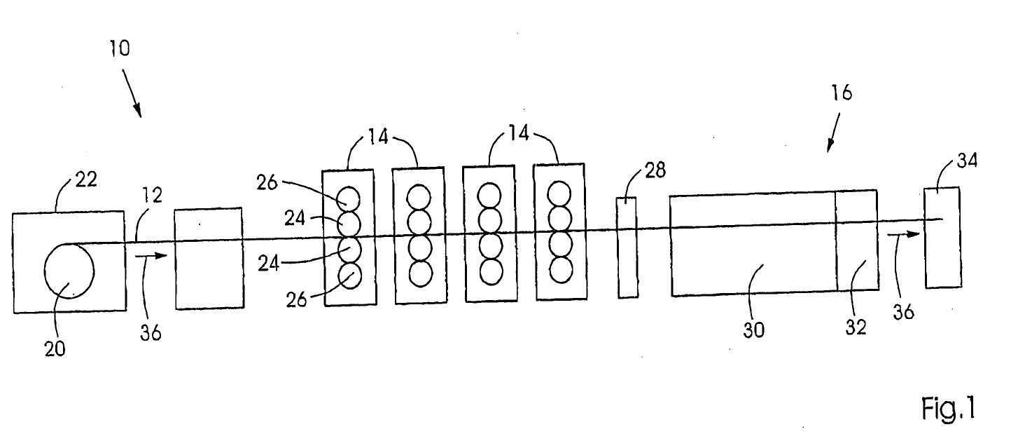

FIG. 1 a schematic of the topology of one embodiment of a printing press according to the present invention;

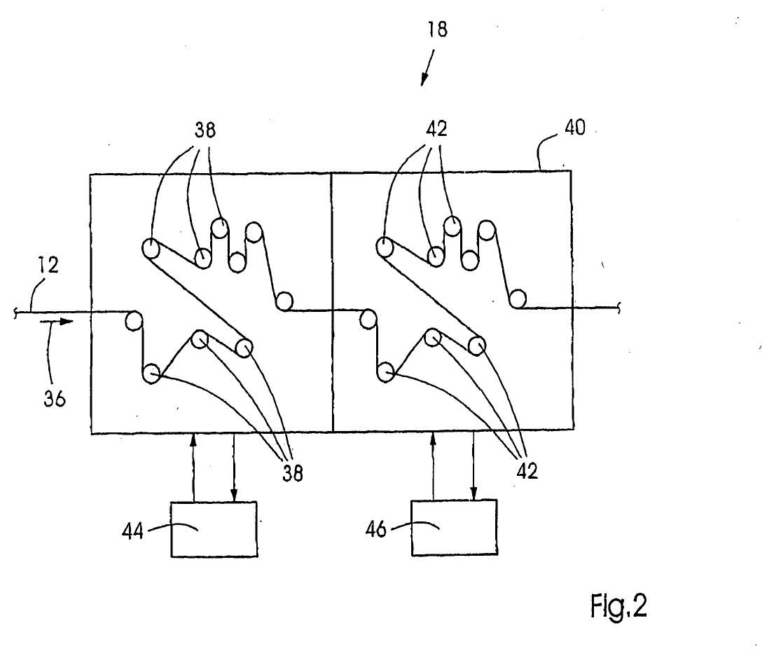

FIG. 2 a schematic representation of one preferred specific embodiment of a device for inputting heat in a printing press according to the present invention;

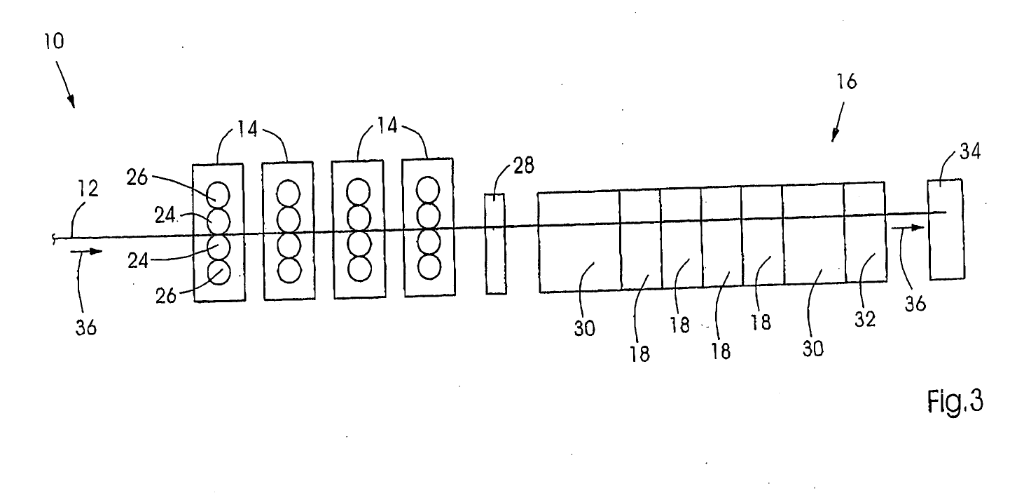

FIG. 3 a schematic of the topology of one alternative embodiment of the printing press according to the present invention; and

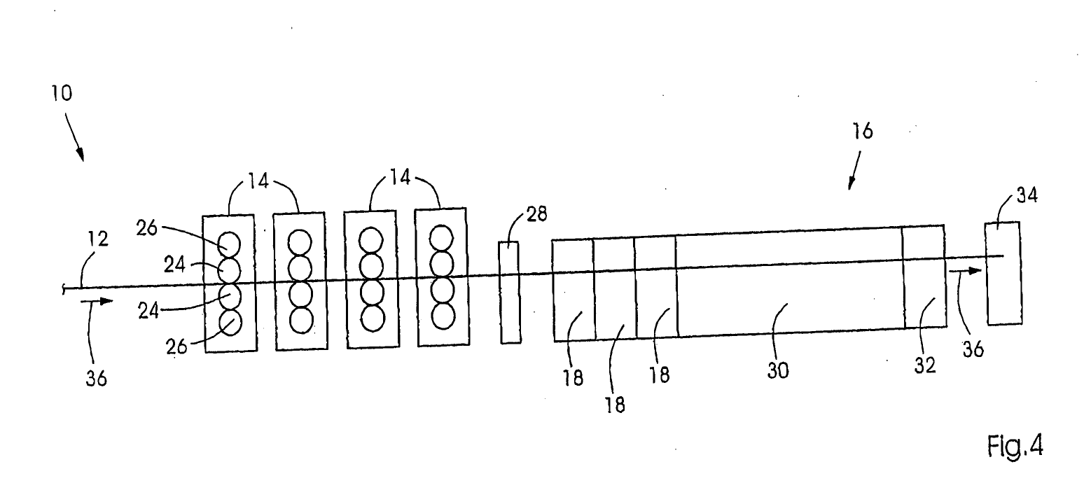

FIG. 4 a schematic of the topology of another embodiment of the printing press according to the present invention.

FIG. 1 schematically depicts the topology of one embodiment of a printing press 10 according to the present invention. Printing press 10 processes a web substrate 12 which is transported along path 36 through printing press 10. Any existing details regarding the path profile, such as curves, meanders or the like, are not shown for the sake of simplifying the graphic representation. In practice, however, such details depend on the configuration of the printing press. Web substrate 12 is unrolled from a web roller 20 in a reel changer 22 and arrives alongs its path 36 in a device 18 for inputting heat. Disposed directly downstream from device 18 are four print units 14, in which blanket cylinders 24 and printing form cylinders 26 are sketched. Print units 14 print on both sides of web substrate 12 in an offset printing process using heat-set inks. After passing through print units 14, the web substrate passes a web catching device 28, which is able to be activated in the case of a web tear. Finally, web substrate 12 arrives in a dryer 16, initially in a blower section 30, then in a chill roll section 32. Imprinted web substrate 12 is dried by hot air in blower section 30 and is subsequently cooled in chill roll section 32. Finally, web substrate 12 arrives along path 36 in a folding apparatus 34 in which end products or signatures are produced by cutting web substrate 12 and folding the printing substrate. Device 18 is able to remove moisture from web substrate 12 before it gets into print units 14, thereby making it possible to minimize or even completely prevent the formation of fluting in the web substrate.

FIG. 2 is a schematic representation of one preferred embodiment of a device 18 for inputting heat in a printing press 10 according to the present invention. In this embodiment of device 18, web substrate 12 runs along its path 36 in a meander form, initially around heatable rollers 38 and then in a cooling unit 40 around chill rollers 42. The roller frames and/or the arrangement of the rollers in device 18 may have features as described in European Patent Application EP 1 201 429 A2. The temperature of heatable rollers 38 in device 18 may be controlled or regulated by a heating-temperature control device 44. A typical heating temperature is approximately between 70 and 90 degrees Celsius. The temperature of the chill rolls may be controlled by a cooling-temperature control device 46. A typical cooling temperature is approximately between 15 and 30 degrees Celsius. At least one web-positioning device, one web-tension control device (for example a dancer roller) and one web-tension measuring device may be integrated in device 18.

FIG. 3 relates schematically to the topology of an alternative embodiment of printing press 10 according to the present invention. Here, web substrate 12 is shown on its path 36, starting from a position directly upstream from print units 14 having blanket cylinders 24 and printing form cylinders 26. Web substrate 12 may come directly from a reel changer or exit a device 18, as shown in FIG. 1. In addition, the web-fed rotary press in accordance with FIG. 3 includes a web catching device 28 and a folding apparatus 34. In accordance with the present invention, in addition to two blower sections 30 and one chill roll section 32, the dryer has one device 18 for inputting heat in four sections, as detailed in FIG. 2 and its description. Device 18 is positioned between the two blower sections 30, the upstream section being approximately twice as long as the downstream section. Thus, device 18 acts on the downstream area of the dryer, for which, in particular, approximately 10% of the moisture vaporization is relevant.

FIG. 4 schematically depicts the topology of another specific embodiment of printing press 10 according to the present invention. Here, web substrate 12 is shown on its path 36, starting from a position directly upstream from print units 14 having blanket cylinders 24 and printing form cylinders 26. Web substrate 12 may come directly from a reel changer or exit a device 18, as shown in FIG. 1. In addition, the web-fed rotary press in accordance with FIG. 4 includes a web catching device 28 and a folding apparatus 34. In accordance with the present invention, in addition to one blower section 30 and one chill roll section 32, the dryer has one upstream device 18 for inputting heat in four sections, as detailed in FIG. 2 and its description. Thus, device 18 acts on the upstream area of the dryer, for which, in particular, approximately 90% of the moisture vaporization is relevant.

### REFERENCE NUMERAL LIST

10 web-fed rotary press

12 web substrate

14 print unit

16 dryer

18 device for inputting heat

20 web roller

22 reel changer

24 blanket cylinder

26 printing form cylinder

28 web catching device

30 blower section

32 chill roll section

34 folding apparatus

36 path

38 heatable roller

40 cooling unit

42 chill roll

44 heating-temperature control device

46 cooling-temperature control device

1-10. (canceled)

11. A web-fed rotary press for printing on a web substrate using heat-set inks in an offset printing process comprising:
at least one print unit;
at least one dryer; and
at least one additional device for inputting heat into the web substrate.

12. The web-fed rotary press as recited in claim 11 wherein the device for inputting heat is positioned upstream from the at least one print unit.

13. The web-fed rotary press as recited in claim 11 wherein the device for inputting heat includes at least one steam-heatable roller or at least one water-heatable roller or at least one microwave source or at least one infrared light source.

14. The web-fed rotary press as recited in claim 11 wherein the device for inputting heat includes at least one cooling unit arranged in a last position along the path of the web substrate through the device for inputting heat.

15. The web-fed rotary press as recited in claim 14 wherein the cooling unit includes a plurality of chill rolls.

16. The web-fed rotary press as recited in claim 11 wherein the device for inputting heat has at least one device for producing a lateral tension in the web substrate.

17. The web-fed rotary press as recited in claim 16 wherein the device for producing lateral tension has a plurality of motorless belts or a plurality of grippers.

18. The web-fed rotary press as recited in claim 11 wherein the device for inputting heat is fed by exhaust air from the dryer.

19. A method for minimizing fluting in a web-fed rotary press for printing on a web substrate using heat-set inks in an offset printing process comprising the steps of:
guiding the web substrate through the web-fed rotary press along a path;
printing on the web substrate by at least one print unit;
drying the web substrate once imprinted at a first location; and
supplying heat to the web substrate at least at one other location along the path through the web-fed rotary press.

20. A method for minimizing fluting in a web-fed rotary press as recited in claim 19 further comprising the step of laterally tensioning the web substrate during the heat input operation at the at least one other location.
